(19) United States
(12) Patent Application Publication
(10) Pub. No.: US 2011/0173236 A1
(43) Pub. Date: Jul. 14, 2011

(54) METHOD AND SYSTEM FOR GENERATING A VIRTUAL PROFILE OF AN ENTITY

(75) Inventors: Gervais OUELLET, Otterburn Park (CA); Jérôme BAIL, Montreal (CA)

(73) Assignees: E-PROFILE, Otterburn Park (CA); 9213-1333 QUEBEC INC., Montreal (CA)

(21) Appl. No.: 12/686,477

(22) Filed: Jan. 13, 2010

(51) Int. Cl. G06F 17/30

(52) U.S. Cl. 707/803; 707/805; 707/E17.005; 707/E17.009

(57) ABSTRACT

The present relates to a method and a system for generating a virtual profile of an entity. The method and system build requests based on available information about the entity. The requests are sent to a plurality of information resources. Responses from the information resources are received and analyzed to identify new information related to the available information. The building of requests, sending of requests, receiving responses and analyzing of responses is repeated for the new information to obtain additional new information. The available information, new information and additional new information is stored in a memory. The virtual profile is prepared based on the stored available information, the stored new information and the stored additional new information.

The present relates to a method and system for generating a virtual profile of an entity. More precisely, the present relates to a method and system for generating a virtual profile based on information extracted from a plurality of information resources.

### BACKGROUND

With the advent of Internet, information is made public and spread rapidly. Internet thus provides a widespread network for searching information. However, reliability of information varies greatly amongst websites.

In the particular context of investigations of individuals, Internet has become an important wealth of information. But extracting valuable information for investigations of individuals from Internet is a painstaking work, which requires patience and knowledge of the resources consulted. More particularly, as individuals may use one or several aliases and nicknames, it is particularly difficult to obtain a reliable virtual profile.

There is thus a need for a method and system for generating a virtual profile of an entity based on information available on a plurality of information resources.

### BRIEF DESCRIPTION OF THE DRAWINGS

In the appended drawings, similar references denote like parts. The following drawings are used for exemplary purposes only, and the present invention is not limited to the particular embodiments depicted therein.

FIG. 1 is flow chart of an aspect of a present method;

FIG. 2 is an exemplary schematic representation of a system for generating a virtual profile of an entity;

FIG. 3 is a graphical representation of an exemplary virtual profile report; and

FIG. 4 is another exemplary schematic representation of the system.

### DETAILED DESCRIPTION

The foregoing and other features of the present method and system will become more apparent upon reading of the following non-restrictive description of examples of implementation thereof, given by way of illustration only with reference to the accompanying drawings.

The present method and system relate to generating a virtual profile of an entity, based on information collected from a plurality of information resources. More particularly, in accordance with one aspect, the present method builds requests by means of a building module adapted to be executed by a microprocessor based on available information about the entity. The requests are sent by the microprocessor to the plurality of information resources, and responses are received by a receiving module adapted to be executed by the microprocessor. The received responses are analyzed by an analysis module adapted to be executed by the microprocessor to identify new information related to the entity. Requests are built for the new information, sent to at least one of the plurality of information resources and responses received and analyzed to obtain additional new information related to the available information. The available information, the new information and the additional new information are saved in a memory Then, the method proceeds with preparing by a reporting module adapted to be executed by the microprocessor the virtual profile based on the stored available information, the stored new information and the stored additional new information.

In accordance with another general aspect, the present system is adapted for generating a virtual profile of an entity. For doing so, the system comprises a building module, a sending module, a receiving module, an analysis module, a memory and a reporting module. The building module is adapted for building requests based on available information. The sending module sends the requests to a plurality of information resources. The receiving module receives responses from the information resources. The analysis module analyzes received responses to identify new information related to the available information. The analysis module provides the new information to the building module for initiating repeating the building of requests, sending of requests, receiving of responses and analyzing of the responses to obtain additional new information. The available information, the new information and the additional new information are stored in the memory. The reporting module prepares the virtual profile based on the stored available information, stored new information and stored additional new information.

In the context of the present method and system, the following terminology is used:

virtual profile: report presenting an analysis of information extracted from the Internet related to an entity;

entity: a particular and discrete unit, such as for example a person, a company, a group of persons sharing one or several characteristics such as for example family, professional interaction, social interaction, recreational interaction, etc.;

information: fact or data related to the entity, such as for example: name, geographic address, phone number, alias, electronic address, nickname, user identification, a Uniform Resource Locator (URL), a postal code, an IP address, a picture or portion thereof, a video or sequence of images, etc.;

information resource: any type of source of information, such as for example websites, databases, documents, archive systems, etc.;

microprocessor: one or several microprocessors functioning independently or concurrently; and

memory: any type of device adapted to store data either temporarily or permanently.

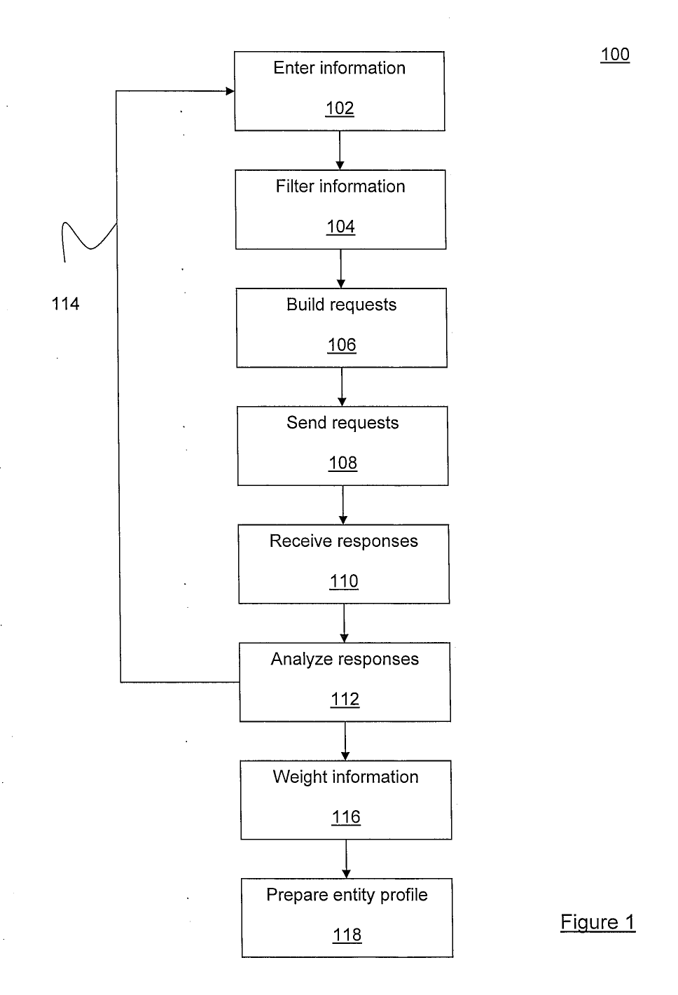

Reference is now made to FIG. 1, which depicts an aspect of a method for generating a virtual profile of an entity. The method starts with entering 102 available information about an entity to be profiled. The available information may consist for example of one or several of the different type of information or several information of the same type if applicable: first name, last name, geographic address, postal code, phone number, picture, e-mail address, URL, social security number, citizenship, nickname, alias, type of car, particular field of interest or activity, hobby, profession, employer, etc. A user may enter the available information on any type of interface that can for example be locally based, web-based, wireless, etc.

The method may then optionally proceed with filtering 104 the available information entered. The filtering may include various aspects. A first aspect may consist of filtering the available information by type of information. For example, all addresses are divided by type of address: geographic address, personal geographic address, employment geographic address, secondary personal geographic address, personal e-mail address, employment e-mail address, etc. Filtering of the available information may further consist of sub-dividing the available information. For example, a personal geographic address may be broken into various sub-fields, such as: number, street, city, province, postal code, and country. Another aspect of the filtering 104 may further consist of pre-formatting the available information. For example, the aliases and nicknames may be used to create new e-mail addresses corresponding to widely used e-mail services such as for example Hotmail™, Gmail™, Mac.com™, etc. Libraries of address formats may be used to optimize the filtering.

The method then continues with building 106 requests. The requests may be built by means of a building module adapted to be executed by a microprocessor. The building 106 of requests may be performed based directly on the available information as entered, or as filtered. Building 106 the requests may consist of several complementary aspects. In a first aspect, the building 106 may consist of identifying which information resources to query based on the available information. For example, if the available information consists of a nickname or an alias, information resources such as for example websites corresponding to social networks could be queried. Thus the building 106 of requests may consider the type of available information, and then identify corresponding information resources of interest. The building 106 of requests may alternately build requests where the available information is queried in all information resources of interest for profiling, regardless of the type of available information. The building 106 of requests may further build a request for all available information either taken independently or concurrently, for all known information resources of interest. In yet another aspect, the building 106 of requests may consist of manipulating a format of the available information so as to make it correspond to a format of at least one of the group of information resources. For example, for a nickname such as ‘007’, e-mail addresses including the nickname “007” are built: 007@hotmail.com, 007@gmail.com, 007@mac.com, etc. In another aspect, the building 106 of requests may further consist of opening a session with websites, which require an active session for performing queries therein.

The method then continues with sending 108 the built requests to a plurality of information resources, such as for example websites. The requests are sent by means of the microprocessor, which opens as required one or several output port(s) on the Internet, so as to send the requests to the corresponding information resources. The group of information resources may include a fixed predetermined group of websites, a customized group of websites selected from the predetermined group of websites based on the type of available information, one or several specific websites based on the content of the available information, public or private databases or documents, or any combination thereof. The requests may be sent either in one batch, in several batches, in series, in parallel, or in any other way. Each request sent may further be labeled with a timestamp.

The method then proceeds with receiving 110 by a receiving module adapted to be executed by the microprocessor, responses from the queried information resources. The responses may be received on one or several input ports, as instructed by the microprocessor. The responses may consist of one or several of the following: error messages, web pages comprising the queried available information, web pages stating that the queried information was not found, accounts of website, etc. The responses thus may comprise the queried available information and corresponding new information.

The method pursues with analyzing 112 the received responses. The analyzing 112 is performed by an analysis module adapted to be executed by the microprocessor. The analyzing 112 comprise several aspects. In a first aspect, the analyzing 112 identifies the responses corresponding to error messages so as to set them aside. In another aspect, the analyzing groups the received responses based on the queried available information. For example, if a nickname yields 20000 hits from search engines, the grouping of the responses based on the queried available information allows determining that many users may use the same nickname, and thus, the new information included in many of the responses may not be reliable or may relate to a different entity. However, if few or no hits are yielded, the probability that the new information included in the responses is reliable is increased. In another aspect, the analyzing 112 identifies in the responses new information. The new information is entered 102 automatically by the analysis module so as to initiate a new iteration of the method for the new information. Furthermore, the analysis module stores the available information, and the new information with an identification of the corresponding information resource in a memory.

Thus the method pursues with repeating 114 of the building of requests, receiving responses and analyzing of the responses for the new information, so as to obtain additional information. The additional new information is then stored also in memory, and the repeating 114 is performed iteratively for any new additional information as long as no new additional information is identified by the analyzing 112. Alternatively, the repeating 114 may be terminated after a predetermined number of iterations.

The method may then optionally continue with weighting 116 by the microprocessor the new information and additional new information stored. The weighting may be based on one or several factors: the information resource from which the new information and the additional new information is received, a number of occurrences of the new information and the additional new information, etc. As certain information resources are known for containing more reliable information, weighting the new information and the additional information based on the information resource from which it is received is a simple way to quickly differentiate the possible reliability of information.

The method then continues with preparing 118 by a reporting module adapted to be executed by the microprocessor, the virtual profile based on the stored available information, new information and additional new information. The preparing may comprise several aspects. A first aspect is the correlating by the microprocessor of the new information and the additional new information to identify one or several trends. For example for the same nickname ‘007’, several responses may have been received. However, some responses further include information about a city, which is different than the city entered in the available information. Thus all new information and additional new information related to the nickname “007” is correlated based on the city, so as to identify the new and additional information related to each city, which become trends. Many other types of correlations may be performed. For example, the microprocessor may correlate the information based on the e-mail address. The same name may be used by different persons on two different e-mail service providers. Thus for example, the e-mail address ABC007@hotmail.com and ABC007@gmail.com may correspond to two different entities. By correlating the other information for each e-mail address, two trends are identified. One trend corresponds to all new information and additional new information related to the e-mail address ABC007@hotmail.com, while the other trend corresponds to all new information and additional new information related to ABC007@gmail.com. By correlating the new information and additional new information, it becomes possible to create multiple courses when preparing the virtual profile, each course corresponding to one of the trends. The correlation may also be performed by comparing the new and additional information, extracted from the received responses, with the available information, so as to identify which trends correspond better with the available information. For example, if one trend identifies a ‘John Doe’ living in New York and using the nickname ‘007’, and another trend relates to a ‘James Doe’ living in Europe and also using the nickname ‘007’, correlating the two trends with the available information assists in determining which trend is the most probable. Various other types of correlations and weighting may be performed with the new and additional information, so as to present the stored new and additional information as different courses.

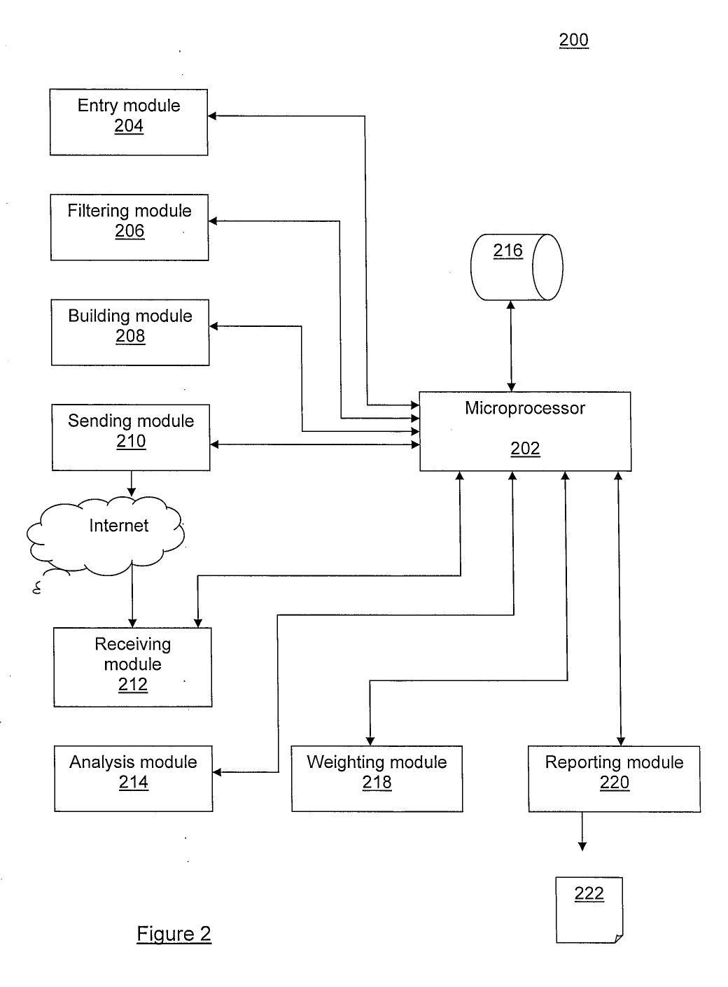

Reference is now made to FIG. 2, which is an exemplary schematic representation of a system for generating a virtual profile of an entity. The system 200 may be realized by a group of software modules adapted to be executed on a microprocessor 202, or in hardware where each module may be performed by one electronic component, divided amongst several electronic components, or grouped in one electronic component. For clarity purposes, the following description will use the terminology module to represent both software and hardware implementations of the present system 200.

The system comprises an entry module 204, a filtering module 206, a building module 208, a sending module 210, a receiving module 212, an analysis module 214, a memory 216, a weighting module 218 and a reporting module 220. The various modules are in one aspect adapted for being executed by the microprocessor 202. The entry module 204 is adapted for providing an interface in which a user, a system or another software may enter the available information. The available information is stored by the microprocessor 202 in the memory 216.

The filtering module 206 is optional. As previously described, the filtering module 206 may include various aspects such as: filtering the available information by type of information, sub-dividing the available information, pre-formatting the available information, etc. The filtered available information is provided to the building module 208 by the microprocessor 202.

The building module 208 is adapted for building requests based on the available information or on the filtered available information. Building 106 the requests may consist of several complementary aspects, which as previously described may comprise: identifying which information resources to query based on the available information, build requests for querying the available information in all information resources of interest, building requests for all available information either taken independently or concurrently for all known information resources of interest manipulating a format of the available information so as to make it correspond to a format of at least one of a group of information resources, opening a session with websites requiring an active session for performing queries therein, etc. The built requests are then provided by the microprocessor to the sending module 210.

The sending module 210 is adapted for sending the built requests through Internet or any other means by which the information resources may be reached. The requests are sent by means of the microprocessor 202, which opens as required one or several output port(s), so as to send the requests to the websites of interest.

Responses are received through the Internet and other communications means such as Ethernet, Virtual Private Network, Intranet, etc. by the receiving module 212. The sending module 210 and the receiving module 212 could alternately consist of one single unit, such as for example, one or several input/output ports. The received responses are provided to the analysis module 214 by the microprocessor 202.

The analysis module 214 is adapted for analyzing the received responses, and more particularly to identify and extract there from new information related to the available information. The analysis module 214 comprises several aspects: identifying the responses corresponding to error messages, grouping the received responses based on the queried available information, identifying and extracting from the responses new information, etc. Any analysis operation that may assist in extracting new information and identifying in the extracted new information possible relevance could be used.

The analysis module 214 further enters through the microprocessor 202 the new information in the entry module 204 so as to initiate another iteration of the filtering/building requests/sending requests/receiving responses for the new information. Furthermore, the analysis module 214 stores the available information, and the new information through the microprocessor 202 with an identification of the corresponding information resource in the memory 216. By entering the new information in the entry module 204, and automatically generating requests for the new information, it is possible to expand the scope of searches performed and obtain more information so as to prepare a more detailed profile 222.

The available information, the new information and the additional new information are all stored in the memory 216 by the microprocessor 202. The memory 216 may further store a list or groups of information resources to be queried. The list and groups of information resources may alternately be provided in a library (not shown) in the software, or in a knowledge module (not shown).

The system 200 may further optionally comprise a weighting module 218. As previously described, the weighting may be based on one or several factors: the information resource from which the information is received, the number of occurrences of the information, the amount of information (eg. near empty profiles get a lower score), the information itself (eg. unheard of names are less reliable), the nature of the information (eg. the age provided by an individual is less reliable than his location), whether the information is corroborated by other results, etc. The weighted information (new and additional) is stored in the memory 216 by the microprocessor 202.

The reporting module 220 prepares the virtual profile 222 based on the stored available information, new information and additional new information. The reporting module 220 correlates the information (available, new and additional) to identify one or several trends. By correlating the information, it is possible to create multiple courses when preparing the virtual profile 222, each course corresponding to one of the trends. The reporting module 220 presents the correlated information in the virtual profile 222. Typically, as some information may correspond to more than one entity, the virtual profile represents multiple courses, each course corresponding to one of the trends.

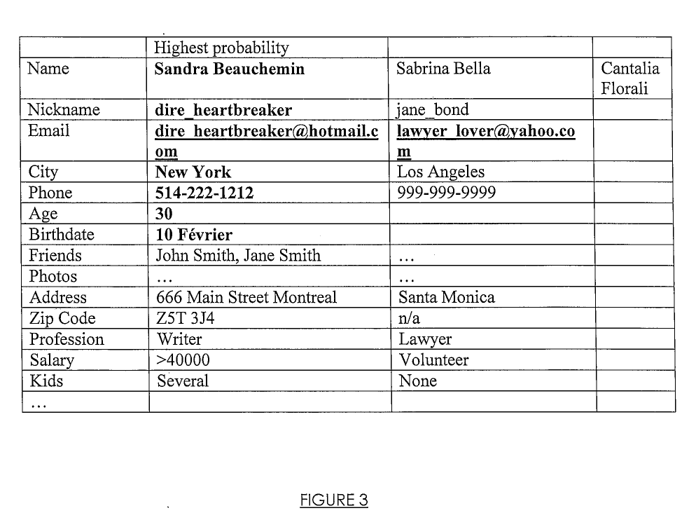

The virtual profile 222 thus provides a summary of the new and additional information extracted from the information resources based on the available information and correlated for reliability. An example of a virtual profile is provided in FIG. 3.

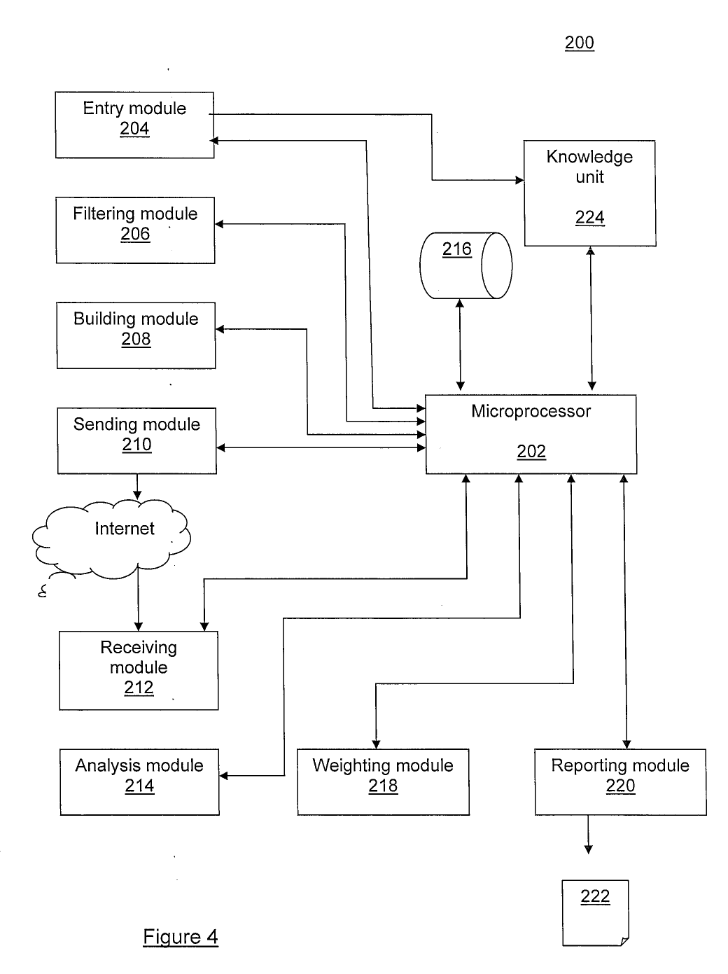

In another aspect, the present system further comprises a knowledge unit 224, as shown on FIG. 4. The knowledge unit 224 may be software or a database adapted to store and maintain information related to the information resources. The knowledge unit could store a list of types of information resources. Examples of types of information resources include social networks, shopping resources, video websites, financial resources, public databases, private databases, etc. For each information resource, the knowledge unit could further comprise an address to access the information resource, and if necessary, a login and password to establish a connection with the information resource. The knowledge unit 224 could further comprise for each information resource instructions for formatting available information into information recognizable by the information resource. The knowledge unit 224 could further comprise for each information resource a list of possible information retrievable from the information resource. In addition, the knowledge unit 224 could further comprise a weight factor, indicative of the credibility of the information provided by the information resource.

The knowledge unit 224 may be dynamically updated by a user through the entry module.

Although the present method and system have been described in the foregoing description by way of illustrative embodiments thereof, these embodiments can be modified at will, within the scope of the appended claims without departing from the spirit and nature of the present method and system.

What is claimed is:

1. A method for generating a virtual profile of an entity, the method comprising:
building by means of a building module adapted to be executed by a microprocessor requests based on available information about the entity;
sending by the microprocessor the requests to a plurality of information resources;
receiving by a receiving module adapted to be executed by the microprocessor responses from the information resources;
analyzing by an analysis module adapted to be executed by the microprocessor the responses to identify new information related to the available information;
repeating the building of requests, sending of requests, receiving of responses and analyzing of the responses to the requests by the microprocessor for the new information to obtain additional new information;
storing the available information, the new information and the additional new information and the information resource from which it has been received in a memory; and
preparing by a reporting module adapted to be executed by the microprocessor the virtual profile based on the stored available information, the stored new information and the stored additional new information.

2. The method of claim 1, wherein the available information is entered by a user.

3. The method of claim 1, wherein the requests are built for the available information by:
manipulating a format of the available information so as to correspond to a format of at least one of the plurality of information resources.

4. The method of claim 4, wherein:
the information resources are categorized by type of information used;
the available information is linked to the type of information; and
the format of the available information is manipulated to correspond to a format corresponding to the information resource.

5. The method of claim 1, wherein the repeating is performed iteratively.

6. The method of claim 5, wherein the preparing the virtual profile further comprises:
weighting by the microprocessor the new information and the additional new information; and
correlating by the microprocessor the new information and the additional new information to identify trends in the received new information and additional new information.

7. The method of claim 6, wherein the weighting is based on the information resource from which the new information and the additional new information is received.

8. The method of claim 7, wherein the weighting is further based on a number of occurrences of the new information and the additional new information.

9. The method of claim 8, wherein the virtual profile comprises multiple courses each corresponding to one of the trends.

10. A system for generating a virtual profile of an entity, the system comprising:
a building module for building requests based on available information;
a sending module for sending the requests to a plurality of information resources;
a receiving module for receiving responses from the plurality of information resources;
an analysis module for analyzing received responses to identify new information related to the available information, the analysis module providing the new information to the building module for initiating repeating the building of requests, sending of requests, receiving of responses and analyzing of the responses to the requests for the new information to obtain additional new information;
a memory for storing entered available information and the new information and corresponding information resource; and
a reporting module for preparing the virtual profile based on the stored available information and the stored new information.

11. The system of claim 10, wherein the available information is entered by a user by means of an entry module.

12. The system of claim 10, wherein the building module builds the requests by:
manipulating a format of the available information, the new information and the additional new information so as to correspond to at least one of the plurality of information resources.

13. The system of claim 12, wherein:
the plurality of information resources are categorized by type of information used;
the available information, the new information and the additional new information are linked to the type of information; and
the format of the available information, the new information and the additional new information is manipulated to correspond to a format corresponding to the information resource.

14. The system of claim 10, wherein the repeating is performed iteratively.

15. The system of claim 14, wherein the reporting module further:
weights the new information and the additional new information; and
correlates the new information and the additional new information to identify trends in the received new information and additional new information.

16. The system of claim 15, wherein the reporting module weights the new information and the additional new information based on the information resource from which the new information and the additional new information are received.

17. The system of claim 16, wherein the weighting is further based on a number of occurrences of the new information and the additional new information.

18. The system of claim 17, wherein the virtual profile comprises multiple courses each corresponding to one of the trends.
